(19) United States
(12) Patent Application Publication
(10) Pub. No.: US 2014/0327386 A1
(43) Pub. Date: Nov. 6, 2014

(54) RADIO-CONTROLLABLE AC-POWERED MOTORS WITH SEVERAL FUNCTIONS

(71) Applicant: Sten R. Gerfast, Mendota Heights, MN (US)

(72) Inventor: Sten R. Gerfast, Mendota Heights, MN (US)

(21) Appl. No.: 13/986,448

(22) Filed: May 3, 2013

(51) Int. Cl. H02P 23/00

(52) U.S. Cl. CPC H02P 23/0004
USPC 318/739

(57) ABSTRACT

This invention relates to radio-controllable AC electric motors, which receives their power from the AC (alternating current) power line. A less costly motor, which is readily controllable is achieved by substituting control-units previously manufactured and existing inside a motor, replacing them with an external RC control which contain similar control-unit's. The external RC controls is less costly than previous control's, making the overall cost of the motor package less costly, with the added bonus of being able to remotely control the motor with, many control function.

### BRIEF DESCRIPTION

This invention relates to inexpensive radio-controllable (R C) electric motors, which receives their power from the AC (alternating current) power line. A less costly motor, which is RC-controllable is achieved by substituting control-units previously existing inside a motor, replacing them with an external RC control which contain similar control-unit's.

The external RC controls is less costly than previous control's, making the overall cost of the motor package less costly, with the added bonus of being able to remotely control the motor. A multitude of motor types, which are described in detail, can be actuated by a sender-unit which is transmitting radio frequencies to an RC receiver-unit generally mounted on or in the motor. The receiver, in turn, translates these frequencies to specific commands for the motor.

A plurality of commands are available. One of the commands are conveyed to a translating unit which, in turn, is turning on the “AC hot line” to the motor, with the “AC neutral line” already connected to the motor.

The commands can have a multitude of functions translating to a multitude of motor speeds, start-stop's and reversals. An RC control with four channels can actuate up to sixteen functions. Other features such as soft start or very low motor speed can be implemented.

In addition to actuating motors, other devises can be actuated including AC relay's, AC actuators and any other AC powered device.

### BACKGROUND AND RELATED ART

Radio control has generally been used in the past to actuate by DC (direct current).

It is normally easier to design a DC actuating RC control for a DC motor, that is of course also powered by DC.

A brushless motor is powered by a series of DC pulses. derived from rectified AC DC current has a limited availability in an industrial plant and is generally not at all available in homes, but AC is readily available everywhere. Therefore most motors in the world, listed below, is operated from AC power.

A brushless motor operating with DC pulses generally has an motor-internal AC rectification unit to make it possible to connect the motor to an AC outlet. This rectified and smoothed DC is used to both drive the windings in the motor as well as its speed control. The speed control of the brushless motor is achieved by varying the width of the DC pulses, also called pulse width modulation (PᵢWᵢMᵢ) These speed controlling DC pulses generally has a complex and expensive circuit to generate the varying pulses.

Some brushless motors today have a feature that allows for a very low rotational speed of the motor-shaft, if it is used for heating or air-condition service.

Similar DC pulses are used for the high, medium and low speed application.

When the thermostat calls for heat or air conditioning, the motor gradually speeds up.

This feature would alleviate the customers complaints about a “clunking noise” during heating or air conditioning motor turn-on. Similar complaints are common when a motor is turned on by a simple switch.

This is also true when an AC motor is turned on that has three (or more) speeds.

3-speed motors has three power leads exiting out of the motor.

Inside a 3 speed motor there are 3 separate windings on it's stator, which is of course is an added expense. These leads are normally connected to a multiple position switch, that switches on the windings abruptly, again creating a noisy start.

The Brushless motor has been described above. Other types are: a Split-Phase motor which has a start winding and a run winding, with the start winding disconnected by a centrifugal switch when the motor speed reaches a certain speed (operates only on AC).

A Permanent Split Capacitor motor (PSC) has a capacitor connected between its start and run-winding and operates only on AC.

Another Induction motor is the Shaded Pole motor which has “shading” coils on each salient pole face, and which again only operates on AC. Another motor that operates on both AC and DC is the Universal motor which has brushes sliding on a “commutator” to get start and run functions.

A DC motor also has brushes sliding on a commutator to get start and run functions. It can only run on DC.

An RC controllable audio device, a toy, and a TV are naturally easier to control by DC. A common trend in the described RC controls have, for the above reasons, been mainly direct current operated.

To make a motor or device radio-controllable incurs of course additional costs, but with today's mass-production of RC controllers the costs of these controllers are dropping.

Replacing the internal complexity of a multi-speed motor, or replacing the internal complexity of a brushfree motor, by an external RC control with command features, gives the customer his required command functions at the same or lower cost, with the added bonus of remote control. The manufacturing cost of the radio-controllable motors described in the present invention could even be less then the cost of the present internal-control-designed motors.

The present radio-controllable AC powered motor invention is cost-effective, eliminating or minimizing the above stated problems.

### THE PRESENT INVENTION

This radio-controllable AC powered motor invention is applicable to many types of motors and could be characterized by its replacement or elimination of control functions normally residing inside a presently manufactured motor and replacing it with RC control functions. It is thereby making a more cost-effective and more convenient motor package.

A hand-held Sending unit has a plurality of push buttons each transmitting a RC frequency to a Receiver unit which is translating these frequencies to specific commands for the motor. A plurality of commands are available. One of the commands are conveyed to a translating unit which, in turn, is turning on the “AC hot line” to the motor, with the “AC neutral line” already being connected to the motor.

The commands can have a multitude of functions translating to a multitude of motor speeds, start-stop's, soft starts and reversals. An RC control with four channels can actuate up to sixteen functions by applying two of the sending unit's push buttons at the same time.

FIG. 1 is describing a radio-controllable AC powered motor invention, applied to a Brushless Motor having driving pulses derived from rectified AC power, a sending unit which is sending radio frequencies to an RC receiver unit, commanding a connection to AC power, further connecting to a rectifier, witch is further connected to a pulse generating circuit. The incoming power to the circuit is from an AC power lead.

A rotation indicating sender is connected to the receiving circuit to synchronize the pulses. The receiving circuit is also connected to a motor coil which in turn is connected to an AC power lead. The motor being a Brushless Motor, wherein the rotor is having attached magnets. The rotor is also having a central shaft.

FIG. 2 is showing a radio-controllable AC powered motor with radio control functions of the motor type generally referred to as a Permanent Split Capacitor motor (PSC). The motor has a RC (radio control) sending unit, which is sending radio frequencies to a RC receiver unit, that is connecting two coils and capacitor in a normal PSC connection, to incoming and out going AC power.

This motor, as well as all PSC motors, has an induction rotor with central shaft.

In FIG. 3 a radio-controllable AC powered motor is shown of the motor type generally referred to as Split Phase. The motor has a RC sending unit which is sending radio frequencies to a RC receiver unit that is connecting two coils in a normal Split Phase connection, that includes a centrifugally operated switch. Incoming and out going AC power is connected by the receiver unit.

FIG. 4 is showing a radio-controllable AC powered motor of the motor type generally referred to as a Universal Motor. The motor has a RC sending unit which is sending radio frequencies to a RC receiver unit that is sending commands to connect AC power to a stator and a rotor using brushes in a common Universal motor design.

Further description of this invention includes a magnified view of the receiving unit in FIG. 5 with possible control options, numbered 1 through 4, that could be added to the previously mentioned controls for the motor.

One view of the present invention's sending unit is shown in FIG. 6, but many alternate designs could be used.

This inventions descriptions are not intended to describe each possible embodiment or every implementation of the present invention. Figures and detailed description described herein is not intended to limit other embodiments.

### BRIEF DESCRIPTION OF THE DRAWING

FIG. 1 is showing an AC powered motor with radio control functions of the motor type generally referred to as a Brush-free motor.

FIG. 2 is showing an AC powered motor with radio control functions of the motor type generally referred to as a Permanent Split Capacitor motor (PSC).

FIG. 3 is showing an AC powered motor with radio control functions of the motor type generally referred to as a Split phase motor. By removing one winding shown with a switch it could also be described as a Shaded Pole motor.

FIG. 4 is showing an AC powered motor with radio control functions of the motor type generally referred to as a Universal motor.

FIG. 5 is showing an magnified view of the internals of a RC receiver unit having a plurality of semiconductors doing actuation and switching functions.

These functions could be options to be added to the previously mentioned functions.

FIG. 6 is showing an sending unit with its plurality of push buttons and with its radio frequency output.

### DETAILED DESCRIPTION OF THE DRAWING

FIG. 1 is showing a radio-controllable AC powered brushless type motor 10 with a RC (radio control) sending unit 11 which is sending radio frequencies 12 to an RC receiver unit 13, further connecting to a rectifier 14 witch is further connected to a pulse generating circuit 15. The incoming power to the circuit 15 is from an AC power lead 18.

A rotation indicating sender 16 is connected to the circuit 15 to synchronize the pulses created in circuit 15. Circuit 15 is also connected to a motor coil 17. which in turn is connected to an AC power lead 19, The motor 10 has a magnet rotor 20 with central shaft 21.

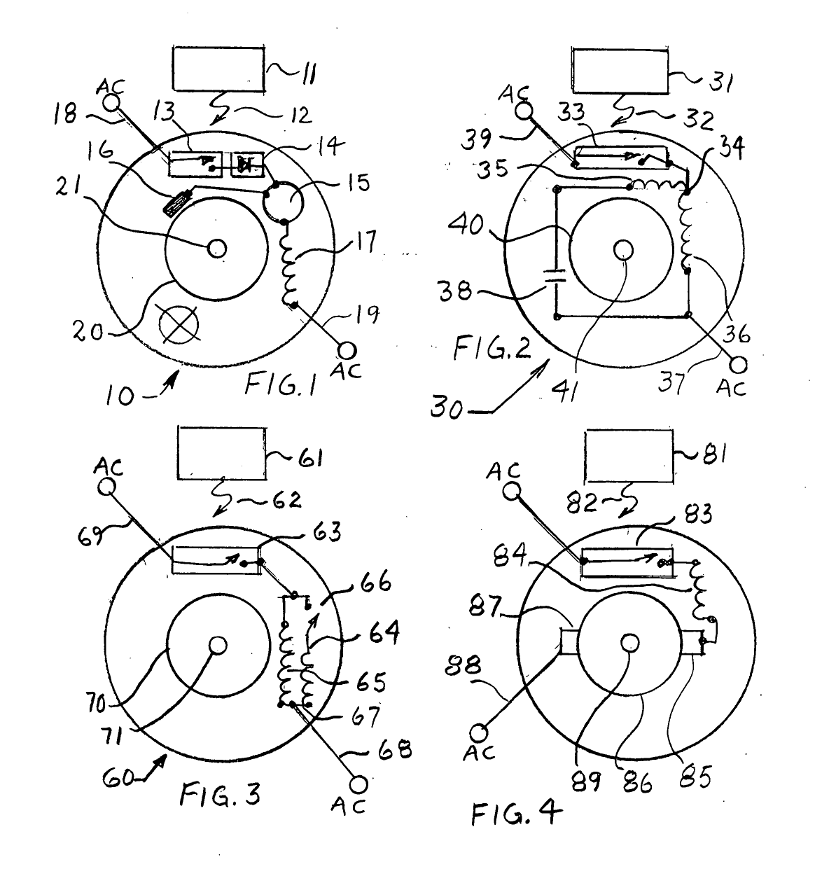

The pulse generating circuit 15, and of all the following motor circuits in FIGS. 2, 3, 4 and 5 which accomplish switch functions by semiconductors are for clarity symbolized by a switch symbol. The word semiconductors in this application is including transistors, mosfets (metal oxide semiconductor field effect transistor) diodes, SCR (silicon controlled rectifier), TRIAC (Three terminal AC switch), IGBT (internal gate transistor) and DIAC's, which conducts AC in both directions.

FIG. 2 is showing an AC powered motor 30 with radio control functions of the motor type generally referred to as a Permanent Split Capacitor motor (PSC). The motor 30 has a RC (radio control) sending unit 31 which is sending radio frequencies 32 to an RC receiver unit 33, further connected to the connection point 34 of coil 35 and coil 36, with coil 36 connected to AC power lead 37.

Coil 34 also is connected to a capacitor 38 with further connection to the AC power lead 37. Circuit 32 is also having an incoming connection to an AC power lead 39. The motor 30 has an induction rotor 40 with central shaft 41.

FIG. 3 is showing an AC powered motor 60 with radio control functions of the motor type generally referred to as Split Phase. The motor 60 has a RC (radio control) sending unit 61 which is sending radio frequencies 62 to an RC receiver unit 63, further connected to a top connection point having two coils 64 and 65. Coil 64 has a centrifugal switch 66. A lower connection point 67 is connected to an AC power lead 68. Receiver unit 63 is also having an incoming connection to an AC power lead 69. The motor 60 has an induction rotor 70 with central shaft 71.

FIG. 4 is showing an AC powered motor 80 with radio control functions of the motor type generally referred to as a Universal motor. The motor 80 has a RC (radio control) sending unit 81 which is sending radio frequencies 82 to an RC receiver unit 83, further connected to a coil 84 connected to a sliding brush 85 with internal connections on the rotor to a sliding brush 87, in turn connected to an AC power lead 88. The rotor has a central shaft 89.

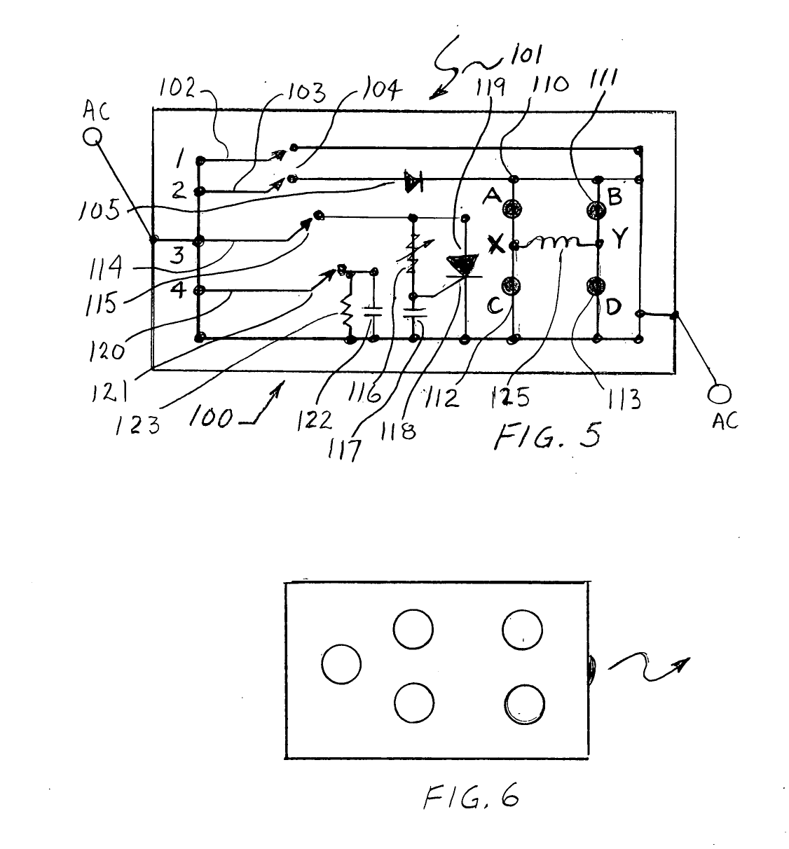

In FIG. 5 is shown an expanded view of a typical receiver unit shown in the above descriptions as number 13 and number 33 and number 63 as well as unit 83.

The receiver unit 100 in FIG. 5, is receiving frequencies 101 causing switching functions in the receiver unit 100. The top 102 input (1) is shown as a normal switching function similar to previous functions. The input 103 (2) is showing a coil reversal unit.

Input 103 (2) has a switch 104 connected to a diode 105 providing positive power to 110 (A) and 111 (B). Points 112 (C) and 113 (D) are grounded.

A coil 115 having End X and End Y is surrounded by semiconductors A, B, C, and D, represented by numbers 110, 111, 112 and 113 accordingly as shown.

As can be seen, when 110 and 113 are turned on, positive power is going through the coil from end X to end Y. When 111 and 112 are turned on, positive power is going through the coil from Y to X, causing the coil power to be reversed.

Input 114 (3) has a switch 115 connected to a variable resistor 116 and a triac 119 connected to ground. The resistor 116 is also connected to a capacitor 117 connected to ground. In between the resistor and the capacitor is a connection to the gate 118 of the triac.

Input 120 (4) has a switch 121 connected to both a capacitor 122 and a resistor 123.

FIG. 6 is showing an sending unit with a general view of its plurality of push buttons. The push buttons can have different shape, size and location.

The sending unit, and its functions, can also be contained in a “mini-computer” or “tablet”.

The word semiconductors in this application is including transistors, mosfets (metal oxide semiconductor field effect transistor) diodes, SCR (silicon controlled rectifier), TRIAC (Three terminal AC switch), IGBT (internal gate transistor) DIAC conducts AC in both directions.

1. A radio-controllable AC powered motor, with a separate radio control sending unit comprising:
an AC powered motor, a separate, external radio control sending unit having multiple control functions that include motor shaft rotation reversibility, multiple speed and soft start capability of said motor, said sending unit connected by radio frequencies to a receiver in said motor, with said receiver connecting AC power to said motor, achieving the listed three control functions.

2. A radio-controllable in-expensive AC powered motor with a separate radio control sending unit comprising:
an AC powered motor of the brushless type having an internal rectifier and an internal circuit capable of providing DC driving pulses to said motors stator, but limited internal functions of reversibility, multiple speed and soft start capability, a separate, external radio control sending unit having multiple control functions that include motor shaft rotation reversibility, multiple speed and soft start capability of said motor, said sending unit connected by radio frequencies to a receiver in said motor, with said receiver connecting AC power to said motor, achieving the listed three control functions.

3. A radio-controllable in-expensive AC powered motor with a separate radio control sending unit comprising:
an AC powered motor of the permanent split capacitor type, a capacitor suited for a permanent split capacitor motor, a separate, external radio control sending unit having multiple control functions that include motor shaft rotation reversibility, multiple speed and soft start capability of said motor, said sending unit connected by a plurality of radio frequencies to a receiver in said motor, with said receiver unit connecting AC power to said motors stator, achieving the listed three control functions.

4. An AC powered motor according to claim 1 wherein the sending units number of functions, are actuated by push buttons on the sending unit, additionally has an LED (light emitting diode) powered to “on” when one push button is pushed, and is remaining in the “on” position until the next push button is pushed, causing the current LED to turn “off”.

5. An AC powered motor according to claim 2 wherein the sending units number of functions, are actuated by push buttons on the sending unit, additionally has an LED (light emitting diode) powered to “on” when one push button is pushed, and is remaining in the “on” position until the next push button is pushed, causing the current LED to turn “off”.

6. An AC powered motor according to claim 2 wherein the sending units number of functions, is actuated by push buttons, and is having the possibility of actuating more then one push button at one time, thereby multiplying the sending units number of functions.

7. An AC powered motor according to claim 2 wherein very low speed is accomplished by an capacitor resistor combination in the AC connection to the stator of the motor, wherein said capacitor's microfarad value is directly determining the current through-put to the stator, described in FIG. 5 section 4, and said capacitor is of the non-polar or foil type.

8. An AC powered motor according to claim 3 wherein very low speed is accomplished by an capacitor resistor combination in the AC connection to the stator of the motor, wherein said capacitor's microfarad value is directly determining the current through-put to the stator, described in FIG. 5 section 4, and said capacitor is of the non-polar or foil type.

9. An AC powered motor according to claim 1 wherein in addition to the described radio control unit sending frequencies into the receiver unit causing actuation, an internal speed modification circuit is co-acting with said actuation; to achieve fine-tuning of motor speed by a phase control circuit described in FIG. 5 section 3.

10. An AC powered motor according to claim 1 wherein in addition to the described radio control unit sending frequencies into the receiver unit causing actuation, is having a an additional circuit accomplishing a reversal of current in a coil in said motor, said reversal is done with four semiconductors in a bridge circuit described in FIG. 5 section 2.

11. An AC powered motor according to claim 1 wherein in addition to the described radio control unit sending frequencies into the receiver unit causing actuation, is having a an additional circuit accomplishing a reversal of current in a coil in said motor, said reversal is done with four semiconductors in a bridge circuit described in FIG. 5 section 2.

12. An AC powered motor according to claim 3 wherein in addition to said receiver unit connecting AC power into the motor stator, a resistor connected into the gate or base of a semiconductor in a phase control circuit is providing additional power to the stator.

13. An AC powered motor according to claim 1 wherein said sending unit and its functions is contained in a mini-computer or tablet.

14. An AC powered motor according to claim 2 wherein said sending unit and its functions is contained in a mini-computer or tablet.

15. An AC powered motor according to claim 3 wherein said sending unit and its functions is contained in a mini-computer or tablet.
